(19) United States
(12) Patent Application Publication
(10) Pub. No.: US 2014/0032923 A1
(43) Pub. Date: Jan. 30, 2014

(54) System and device for authenticating a user

(71) Applicant: Harald Marthinussen, Ski (NO)

(72) Inventor: Harald Marthinussen, Ski (NO)

(73) Assignee: EKA A/S, Ski (NO)

(21) Appl. No.: 13/561,450

(22) Filed: Jul. 30, 2012

(51) Int. Cl. G06F 21/00; G06F 7/04

(52) U.S. Cl. 713/186; 726/5; 726/7

(57) ABSTRACT

A system for authenticating a user trying to access a service (22, 32), said system including a device (11) with a CPU (12), ROM (13), RAM (14), at least one biometric reader (18, 114, 110), and communication means (112, 113), the device being operated only by data permanently stored in the ROM (13), the RAM (14) being flushed after each operating cycle. The system further includes servicing equipment (21, 31, 41) communicating with the device (11), said equipment being adapted to
verify the integrity of the device,
ask for biometric readings identifying the user,
compare said biometric readings with stored biometric data for verifying the authenticity of the user,
in case the user being authenticated, providing access to the service (22, 32).

### FIELD OF THE INVENTION

The present invention relates to a system and device for verifying the identity of a person. The invention is a device to be used by everybody, but it will only be unique to the user. The main function of the invention is to provide personal safety and personal simplicity in a digital world. The invention can be described in many ways. Here are a few description possibilities: Personal or Private Connection Unit—PCU, Personal or Private Contact Unit—PCU, Personal or Private Crypto Unit—PCU, Personal or Private Security Unit-PSU, Personal or Private Recognition Unit—PR or PRU, I will have an easy life with—iLife, I obtain better Security with—iSec , I will be Safe with—iSafe and so on. A “nice pet” deserve many proper names.

### BACKGROUND

In today's society more and more services are dependent on the user identifying her/himself with a user ID/password, ID code, card, key, dongle etc. Apart from the strain of having to remember a lot of codes, the exchange of information makes the user vulnerable for theft, for example by onlookers gleaning the codes entered into

ATM or used for opening a door, criminals mounting skimmers on banking automates, phishing or obtaining ID codes in other ways, or by hackers breaking into personal computers or breaking codes for using a service.

It is well known that criminals have emptied bank accounts of unlucky victims and even taken over their “Cyberworld” identity.

There have been attempts of solving this problem by using biometric readings for identifying a user, e.g. for unlocking a door or for gaining access to an account on a personal computer. However, such systems requires the user to be registered in advance, and are also only as secure as the system itself, i.e. a hacker may break the system, “get inside”, and get access to the ID codes.

### SUMMARY OF THE INVENTION

Thus, there is a need for a more secure personal identification system that is easier to use and may help the user from having to remember a lot of identification codes.

This object is solved by the present invention, as it is defined in the following claims.

In particular, the present invention relates to a system for authenticating a user of a service. The system includes a device for authenticating the user with a CPU, ROM, RAM, at least one biometric reader, communication means and power supply means, the device being operated only by data permanently stored in the ROM, the RAM being flushed after each operating cycle, an equipment communicating with the device, said equipment being adapted to
verify the integrity of the device,
ask for biometric readings identifying the user,
compare said biometric readings with stored biometric data for verifying the authenticity of the user,
in case the user being authenticated, providing access to the service.

### BRIEF DESCRIPTION OF THE DRAWINGS

The invention is now to be described in detail in reference to the appended drawings, in which:

FIG. 1 is a schematic illustration of an identification device according to the present invention,

FIG. 2 illustrates how the inventive device may co-operate with conventional PC and portable devices for accessing services on the internet,

FIG. 3 illustrates how the inventive device may be used for accessing financial services,

FIG. 4 illustrates how the inventive device may be used to un-lock gates in general, for accessing and starting various vehicles, open gates and gain access to your house and other household appliances.

### DETAILED DESCRIPTION

As shown in the drawings, the invention relates to a small portable device 11 that is communicating with equipment for accessing a service 21, 31, 41. When approaching a service requesting identification information about the user, the device may identify the user using biometric scanning, and provide clearing information to the equipment providing access to the service. The service in question may be such as unlocking the front door of your house, opening and starting your car, logging you to any service on the internet, withdrawing cash from banking automates, etc. The device is your unique access to start equipment such as your portables; PC, phone, iPad®, iPhone®, smart phone, Android® and Pad. The device also becomes your unique unit to secure the access to your authorized websites; storage cloud, office system, Dropbox®, SkyDrive®, iCloud®, smart Cloud®, bank accounts, net payments, tax payment and government sites. It will be unnecessary to remember usernames, puck codes, password and so on as the inventive device recognizes and can authorize you.

All you need is a device according to the invention and corresponding apps installed at the service or the different equipment you use. You do not have to remember any passwords anymore, as the system takes care of the identification and authorization. The sole purpose of the device is to recognize you and verify your unique personal identifications in a digital way where ever you go. The device will connect to the service/equipment in question, through a direct or wireless connection.

The device acts as a terminal and do not contain any personal information. That is, you may use any such device available for you, and nobody may take benefit of a device if you should lose your device, in case the device is found by a dishonest person. The system will protect you as no one else can start up and use your digital equipments, even when they are stolen. Parents have children control when youngsters cannot connect to forbidden or private restricted areas.

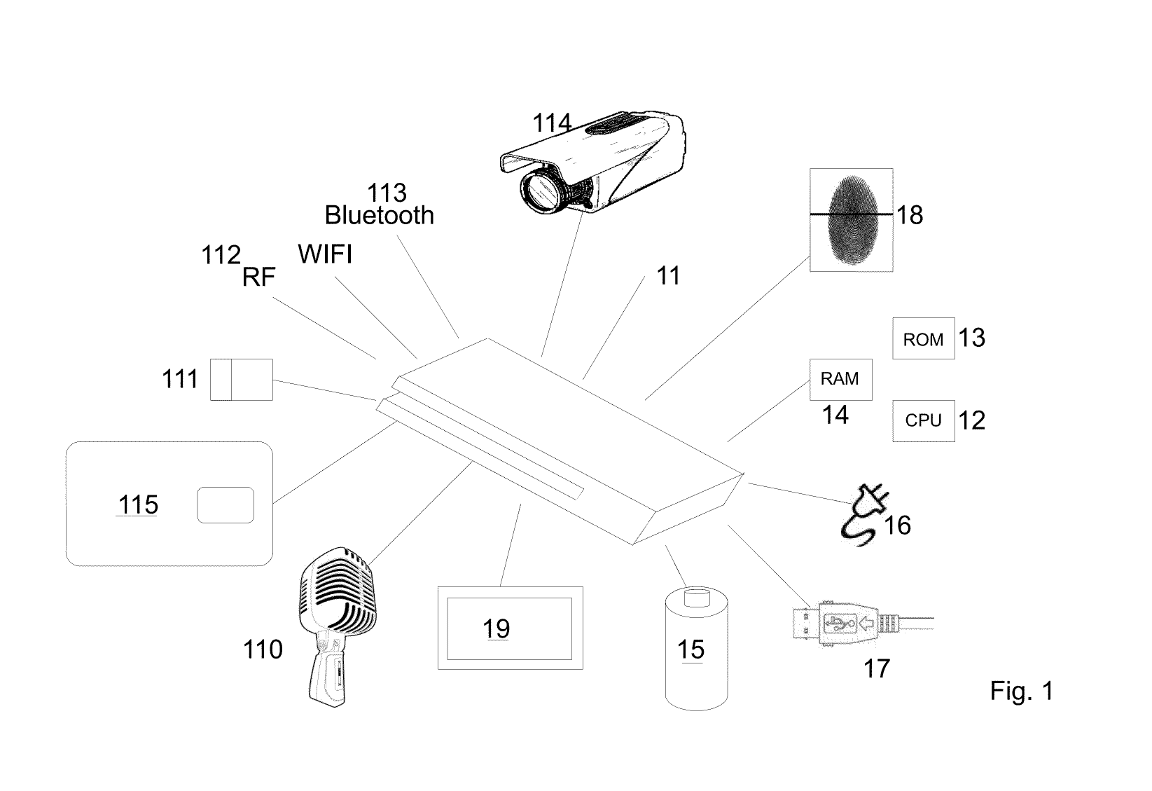

As shown in FIG. 1, the device 11 includes a microcomputer chipset 12, RAM 14, and ROM 13 for BIOS. The biometric reading equipment may include an eye scanner as iris/eye color circle or face shape reader (with a camera 114 using infrared light with option to use Retinal Scan). The device may also include a biometric fingerprint reader 18. In addition to a sound generator the device includes a voice and sound recognition microphone 110, a voice recognition function for recognizing streamed cryptic sound waves and short word strings using hash table functions SHA 256 bit versions, Super Beam®, and or USBD-SA stereo microphone recognitions together with a sound APP or “Dragon® type” speech and sound recognition programs. The device has also a distance indicator (“proximity badge”) and a small display 19. There is also a smarts card reader 111 to read your credit, bank, passports and tax cards. The device 11 runs on a rechargeable battery 15, which is recharged or powered by USB, Power-Backup, a DC car adapter, AC adapter, or solar panel. The device communicates by Thunderbolt® or USB (micro USB connection) 17 and/or wireless using an all-around wireless solution; Bluetooth® 113, Wi-Fi 112, RF and/or 3/4G working with an built in antenna. The units use the same components and chip sets used in most portable units and can implement important new standards as they occur. Today standards are IEEE 802.11b, IEEE 802.11g, IEEE 802.11n, RF, Bluetooth®, 3G and 4G.

An important aspect of the invention is that the device does not include any storage, i.e. no outside part may store instructions in the device. The device is only able to read instructions hard programmed in ROM 13 and the RAM 14 will be flushed after each session. Without data storage you cannot be robbed for biometric data or passwords if the device is lost or stolen. The device will only generate encrypted data so “your private biometry” remains a secret and cannot be used, i.e. misused, by others. As the device has no recollection when stolen or lost your private data and password are not compromised.

The inventive device is adapted to read biometric information identifying the user, encrypt the information and transmit the information to servicing equipment 21,

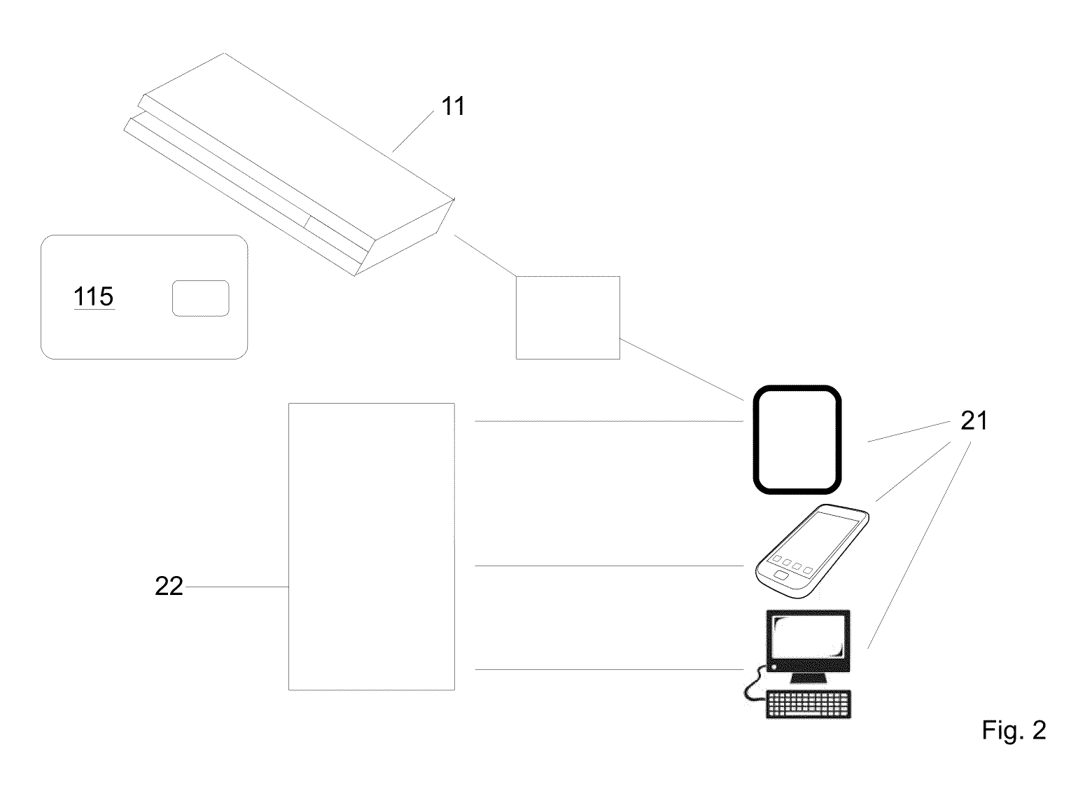

FIG. 2. The servicing equipment 21 may be a PC, iPhone®, iPad®, SmartPhone® etc., with an app installed. The servicing equipment provide access to services 22 on the Internet, e.g. for file storage, backup services etc. known under trade names such as SkyDrive®, Dropbox®, IBM SmartCloud®, IBM ObjectStorage®, iCloud®, g+®, FaceBook®, Twitter®, YouTube®. When approaching or starting servicing equipment, e.g. pressing the “power on” button on your portable (PC, Mac®, Pad, Iphone®, Android® . . . ) it will send a signals to the device to identify the device as an original and un-tampered unit, by checking a QR coded unique number with parity check or other “unidentified” coding before it requesting the biometric unit (e.g. fingerprint reader 18) to start up. You can preset your portable for a higher security level by requesting automatically two or more different verifications. Such as two different finger print readings and a text string reading or maybe one fingerprint reading, an eye scanning and a text string reading. A user having a damaged finger, damaged voice or a sick eye may order the portable to ask the device to select other biometric readings by depressing a button such as “enter”, “delete”, “return”, “FN” or “power on” button one or more times. The biometric reading includes to verify one or more of your personal data as fingerprint, an iris eye color circle reader, voice and face shape recognition reader. It can also generate “verification sound” with a sound generator and even read your biometric-chip on your bankcard or passport.

The communication between the device and the unit is encrypted. All signals are scrambled by a security chip such as TPM type for sending only encrypted data. The device may in some applications also be restricted to short range communication (some centimeters or even less) to prevent other parties from receiving and trying to decode the information. When activating the proximity function between your portable and the device in your pocket you can also stop others from using an ongoing session when disturbed by coworkers or family. With the proximity function activated you can prevent people using your portable unit if you have to leave your powered on unit behind. The proximity function uses a “proximity badge” as mentioned above.

The device may be made small enough to be attached on to your portable telephone or carried in your pocket, in your purse or in your wallet. The device may be produced small, thin and very integrated without changeable parts and may be covered with a clear, look through, plastic type substance, to secure the possibility of rebuilding fake versions to be used for copying (stealing) biometric data. All original products should have a “QR-bar-coded” serial number you can verified either through wireless communication or just scanned by a barcode scanner from outside. All original products are marked with a QR coded serial number having a new “unidentified/secret” color coded parity check or other “unidentified” coding on to the QR image. The original App downloaded from the producer of the device has built in software to authorize the device. A “all in one” version of the device will also be available with a design to be implemented in many gadgets; in a PC, in a Tab, in a key holder, in a smart phones, in a “locket” on a chain or necklace, in a bracelet (jewelry), attached to your glasses, in a watch or just as a “thick ½ size credit card”. Producers of portable digital equipment (PC, Androids®, TABs, telephones, . . . ) can implement a slot in their equipment to just slide the device in place; similar to other micro cards, PCMCIA cards, memory cards . . . slots.

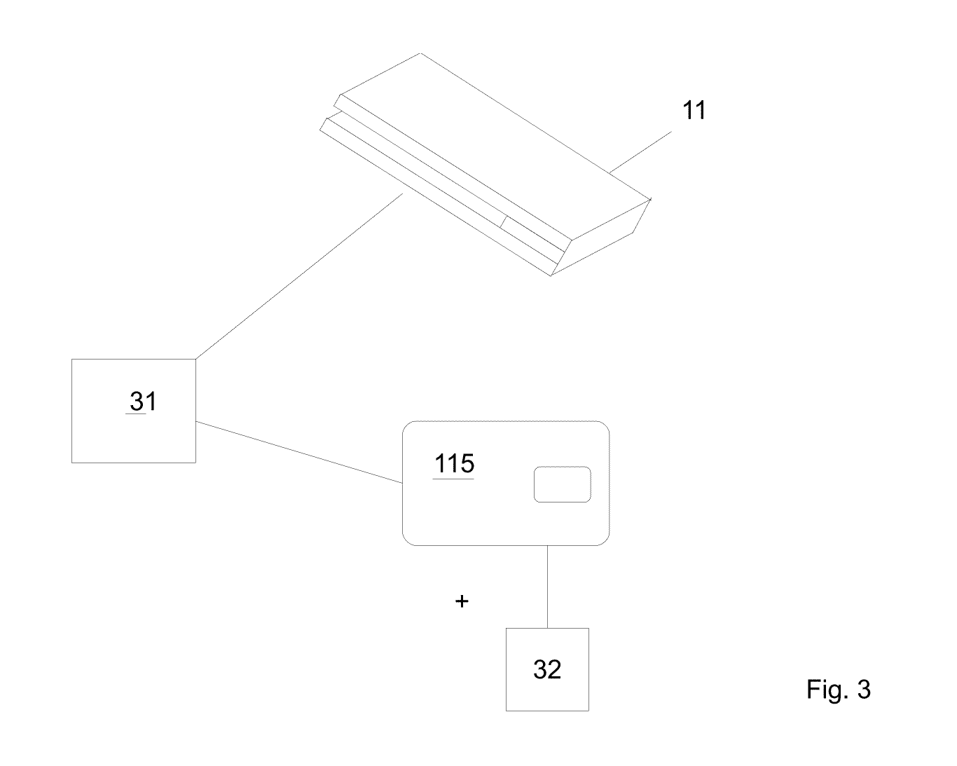

FIG. 3: Your bank card, Social security card, passport and credit cards 115 can all be produced (box 31) with 1, 2, 3 or 4 of your PCU cryptic data as part of your private microchip card and as part of their security database when the bank, government or credit card company issue your new security card. The new microchip security cards together with this device can be used for secure payments at the store, secure withdrawals of your money from the bank, for you checking in and passing at airport terminals 32. When verifying your personal card at a terminal against a central file and at the same time matching your biological data encrypted in the card with the same biological cryptic data you produce with a device you cannot be anybody else. This way, sick, old and handicapped people are also safe for unauthorized withdrawals. Assistants can only verify their own identifications with a device and then the bank can record all authorized “cash card” withdrawals. The card may also be inserted into a slot in the inventive device. Then, the biometric readings will be verified by comparing with biometric data stored in the card, and the result transmitted to the external equipment, preferably on a wireless link. This may be a handy solution for making payments in a shop.

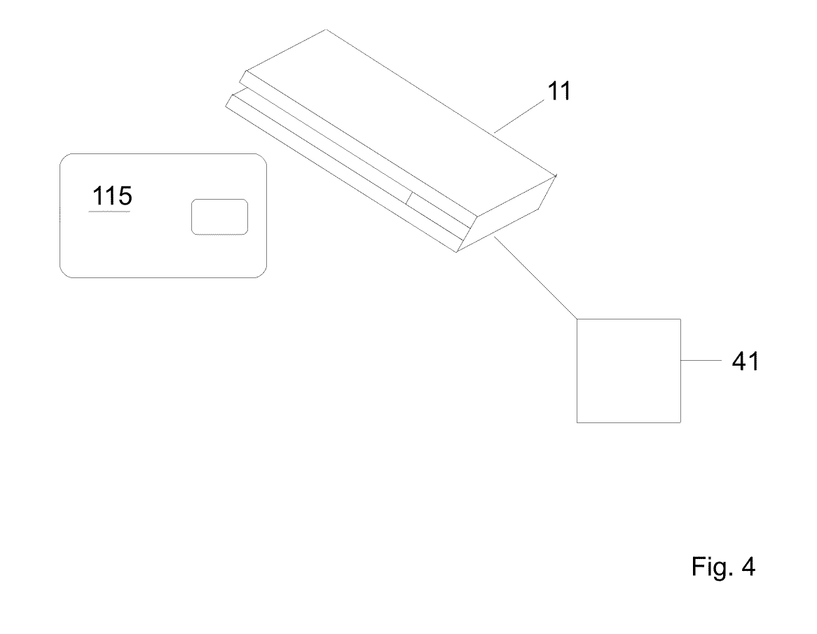

FIG. 4: Manufacturers can also implement a security ROM in service equipment 41, such as computer controlled cars, boats, boat motors, MCs, door locks and even in a bike lock. The manufactures then have to supply ROM burners with the proper

App to their “authorized dealers” (in some cases EPROM can also be used with a lower security). Dealers can then program the device codes for new owners to use for unlocking and starting the cars, MCs and boat. When the car is resold a dealer can program a new ROM (or reprogram the EPROM) to fit new owners. The car, boat, MC thieves will have a hard time stealing and selling products when everybody is using devices to verify their biometric data to start and drive. Children without driver license not signed up on the ROM (EPROM), cannot start up and drive their family boats, cars, MC i.e. and hurt themselves anymore. A dealer can of course reprogram stolen cars, but then the thief will have to use his own identity to drive.

1. A device (11) for authenticating a user comprising a CPU (12), ROM (13), RAM (14), at least one biometric reader (18, 114, 110), communication means (112, 113), power supply means (15), the device being operated only by data permanently stored in the ROM (13), the RAM (14) being flushed after each operating cycle.

2. A device according to claim 1, wherein the communication means including wireless communication means.

3. A device according to claim 1, wherein said biometric reader includes at least one of a fingerprint reader (18), an eye scanner and/or face shape reader (114), a voice and sound recognition system (110).

4. A device according to claim 1, the device further including a display (19), a speaker and a card reader (111).

5. A device according to claim 1, the device further including a proximity badge.

6. A system for authenticating a user of a service comprising, a device (11) with a CPU (12), ROM (13), RAM (14), at least one biometric reader (18, 114, 110), communication means (112, 113), power supply means (15), the device being operated only by data permanently stored in the ROM (13), the RAM (14) being flushed after each operating cycle, an equipment (21, 31, 41) communicating with the device (11), said equipment being adapted to
verify the integrity of the device,
ask for biometric readings identifying the user,
compare said biometric readings with stored biometric data for verifying the authenticity of the user,
in case the user being authenticated, providing access to said service (22, 32).

7. A system according to claim 6, wherein the device or the equipment includes a card reader (111) for reading microchip security cards (115) storing encrypted biometric data.

8. A system according to claim 6, wherein said biometric data are stored in said equipment or are provided by the service from an external storage.

9. A system according to claim 6, further including means for determining the distance between said device and said equipment, the means being adapted to deny access to the service in case the distance exceeds a predefined limit.

10. A system according to claim 6, wherein the device includes a readable code marking, said equipment being adapted to read said code and authorize the device.
